(19) United States
(12) Patent Application Publication
(10) Pub. No.: US 2026/0070170 A1
(43) Pub. Date: Mar. 12, 2026

(54) SCREW FASTENING METHOD FOR FASTENING OBJECT MEMBER AND SCREW FASTENING DEVICE

(71) Applicants: SUBARU CORPORATION, Tokyo (JP); SHIBAURA INSTITUTE OF TECHNOLOGY, Tokyo (JP)

(72) Inventors: Taro MAEYAMA, Tokyo (JP); Tetsuo FUKUDA, Tokyo (JP); Yuji FUSHITANI, Tokyo (JP); Kazuyoshi NOJIRI, Tokyo (JP); Hideki NINAGAWA, Tokyo (JP); Shinji HASHIMURA, Chiba (JP); Kanta FURUYA, Kanagawa (JP); Kengo TAKAHASHI, Tochigi (JP)

(21) Appl. No.: 19/321,893

(22) Filed: Sep. 8, 2025

(30) Foreign Application Priority Data
Sep. 10, 2024 (JP) 2024-156655

(51) Int. Cl. B23P 19/06

(52) U.S. Cl. CPC B23P 19/066

(57) ABSTRACT

A screw fastening method for a fastening object member includes: tightening a screw fastening member in a tightening direction up to a first tightening torque; loosening the screw fastening member in a loosening direction opposite to the tightening direction and detecting a maximum value of a loosening torque; re-tightening the screw fastening member in the tightening direction up to a second tightening torque after the maximum value of the loosening torque is detected; and calculating the target tightening torque and tightening the screw fastening member up to the target tightening torque. The target tightening torque is calculated using a loosening direction torsion angle of a bolt of the screw fastening member when the screw fastening member is loosened and a tightening direction torsion angle of the bolt when the screw fastening member is re-tightened.

### CROSS-REFERENCE TO RELATED APPLICATIONS

This application is based on and claims priority under 35 USC 119 from Japanese Patent Application No. 2024-156655 filed on Sep. 10, 2024, the entire content of which is incorporated herein by reference.

The present disclosure relates to a screw fastening method for a fastening object member and a screw fastening device.

As a torque coefficient measurement device in the related art, for example, a measurement device described in Japanese Unexamined Patent Application Publication JP-A S60-60525 is known. The torque coefficient measurement device in the related art corresponds to a torque method, and is a device for calculating an appropriate tightening torque in relation to a torque coefficient in order to obtain an appropriate axial force when a bolt is used as a fastening member.

The torque coefficient varies depending on a friction coefficient of a screw thread contact surface of the bolt, a friction coefficient between a bolt head portion or a seating surface of a nut and a contact surface of the fastening object member, and the like. It is known that the tightening torque varies significantly for each bolt.

As a screw fastening method in the related art, for example, a method described in Japanese Unexamined Patent Application Publication JP-A H04-30975 is known. In the screw fastening method in the related art, a torque at the time of tightening a workpiece to a base material by a screw is measured, a torque at the time of loosening the screw is measured, and a tightening torque required for a predetermined tightening force is calculated based on a difference between both the torques.

### SUMMARY

An aspect of the present disclosure provides a screw fastening method for a fastening object member that uses a screw fastening member to couple the fastening object member by screw tightening with a target tightening torque corresponding to a predetermined target tightening axial force. The screw fastening method includes: tightening the screw fastening member in a tightening direction up to a first tightening torque; loosening the screw fastening member in a loosening direction opposite to the tightening direction and detecting a maximum value of a loosening torque; re-tightening the screw fastening member in the tightening direction up to a second tightening torque after the maximum value of the loosening torque is detected; and calculating the target tightening torque and tightening the screw fastening member up to the target tightening torque. The target tightening torque is calculated using a loosening direction torsion angle of a bolt of the screw fastening member when the screw fastening member is loosened and a tightening direction torsion angle of the bolt when the screw fastening member is re-tightened.

An aspect of the present disclosure provides a screw fastening device configured to use a screw fastening member to couple a fastening object member by screw tightening with a target tightening torque corresponding to a predetermined target tightening axial force. The screw fastening device includes a tightening mechanism configured to tighten or loosen the screw fastening member disposed on the fastening object member, a torque measurement mechanism configured to measure a torque when the screw fastening member is tightened or loosened by the tightening mechanism, and a control unit. The control unit is configured to: perform a temporary tightening operation of tightening the screw fastening member in a tightening direction up to a first tightening torque using the tightening mechanism, and then perform a loosening operation of loosening the screw fastening member in a loosening direction opposite to the tightening direction; detect a maximum value of a loosening torque during the loosening operation using the torque measurement mechanism, and then perform a re-tightening operation of tightening the screw fastening member in the tightening direction up to a second tightening torque using the tightening mechanism; and calculate the target tightening torque using a loosening direction torsion angle of a bolt of the screw fastening member during the loosening operation and a tightening direction torsion angle of the bolt during the re-tightening operation.

An aspect of the present disclosure provides a screw fastening device. The screw fastening device includes a screw fastening member, a tightening mechanism, a torque measurement mechanism, and a processor. The screw fastening member is configured to couple a fastening object member by screw tightening with a target tightening torque corresponding to a predetermined target tightening axial force. The tightening mechanism is configured to tighten or loosen the screw fastening member disposed on the fastening object member. The torque measurement mechanism is configured to measure a torque when the screw fastening member is tightened or loosened by the tightening mechanism. The processor is configured to execute a program stored in a memory. The processor is configured to, when the program is executed by the processor, cause the screw fastening device to execute: tightening the screw fastening member in a tightening direction up to a first tightening torque using the tightening mechanism, and then loosening the screw fastening member in a loosening direction opposite to the tightening direction; detecting a maximum value of a loosening torque during loosening the screw fastening member using the torque measurement mechanism, and then re-tightening the screw fastening member in the tightening direction up to a second tightening torque using the tightening mechanism; and calculating the target tightening torque using a loosening direction torsion angle of a bolt of the screw fastening member during loosening the screw fastening member and a tightening direction torsion angle of the bolt during re-tightening the screw fastening member.

### BRIEF DESCRIPTION OF DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a schematic view illustrating a screw fastening method for a fastening object member according to an embodiment of the present disclosure;

FIG. 2 is a flowchart illustrating the screw fastening method for the fastening object member according to the embodiment of the present disclosure;

FIG. 3 is a diagram illustrating the screw fastening method for the fastening object member according to the embodiment of the present disclosure;

FIG. 4 is a diagram illustrating the screw fastening method for the fastening object member according to the embodiment of the present disclosure;

FIG. 5A is a schematic view illustrating a screw fastening device for performing a screw fastening method for a fastening object member according to an embodiment of the present disclosure;

FIG. 5B is a block diagram illustrating the screw fastening device for performing the screw fastening method for the fastening object member according to the embodiment of the present disclosure;

FIG. 6 is a diagram illustrating a result of a verification experiment of the screw fastening method for the fastening object member according to the embodiment of the present disclosure;

FIG. 7 is a diagram illustrating a result of a verification experiment of the screw fastening method for the fastening object member according to the embodiment of the present disclosure; and

FIG. 8 is a diagram illustrating a result of a verification experiment of the screw fastening method for the fastening object member according to the embodiment of the present disclosure.

### DETAILED DESCRIPTION

The torque coefficient measurement device described in JP-A S60-60525 uses an axial force detector or a torque detector in order to measure a torque coefficient with high accuracy in a short time. In addition, the torque coefficient measurement device includes a calculation and display device that calculates and displays a torque coefficient using a detection value from the device. The torque coefficient measurement device in the related art is implemented as an automation device, so that a measurement value can be acquired with high accuracy in a short time.

However, the torque coefficient measurement device in the related art is a measurement device using the torque method, and does not improve the variation itself in the friction coefficient of the screw thread contact surface of the bolt or the friction coefficient between the bolt head portion or the seating surface of the nut and the contact surface of the fastening object member, which is generated at the time of screw fastening. Therefore, there is a problem that the tightening torque required for the predetermined tightening force varies for each bolt due to the variation in the friction coefficient, and an error thereof increases.

As described in JP-A S60-60525, it is theoretically possible to calculate the tightening torque with high accuracy by using the screw fastening method described in JP-A H04-30975 in order to avoid the error of the tightening torque due to the influence of the torque coefficient.

However, the screw fastening method in the related art focuses only on the torque, and includes a step of loosening the screw after tightening the screw, so that the tightening torque at the time of tightening the screw depends on a dynamic friction coefficient. The loosening torque at the time of loosening the screw depends on a static friction coefficient. As a result, there also is a problem that it is less likely to reduce the error of the tightening torque required for the predetermined tightening force due to the variation in the friction coefficient in the screw fastening method in the related art.

The present disclosure provides a screw fastening method for a fastening object member and a screw fastening device that calculate a tightening torque corresponding to a target tightening axial force with high accuracy using a torsion angle of a bolt and a tightening torque at the time of tightening and loosening during a screw fastening operation.

Hereinafter, a screw fastening method for a fastening object member according to an embodiment of the present disclosure will be described in detail with reference to the drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

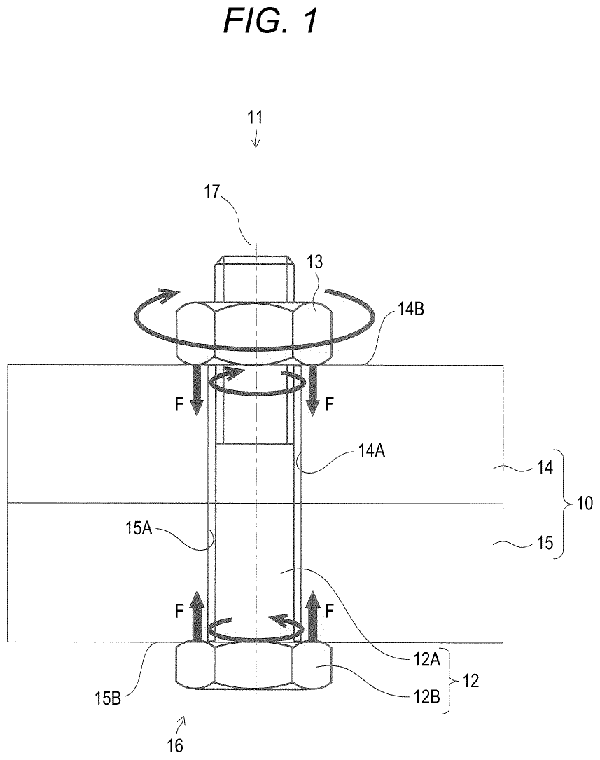

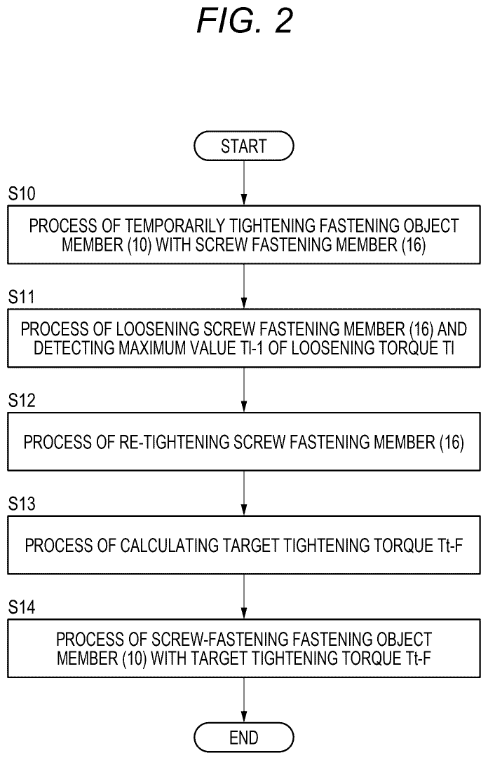

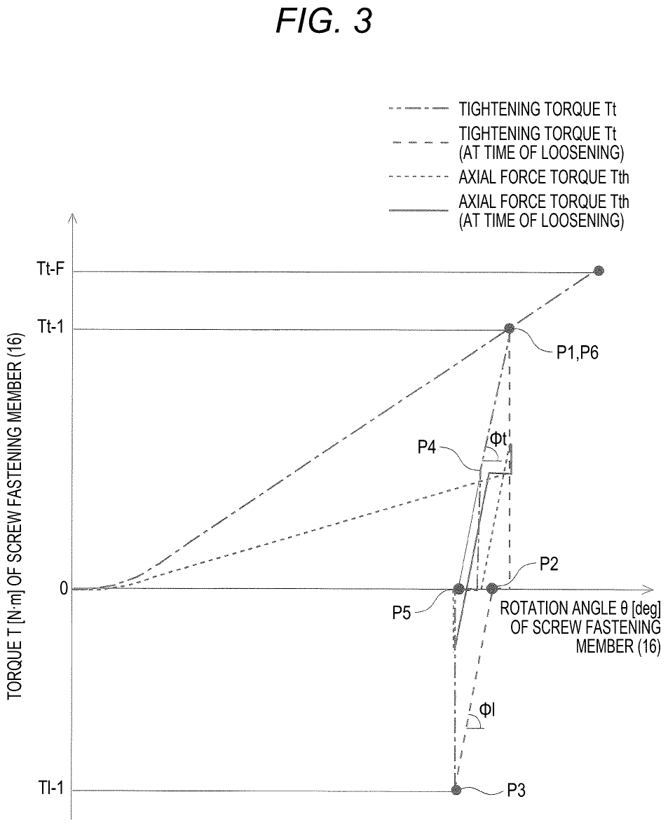

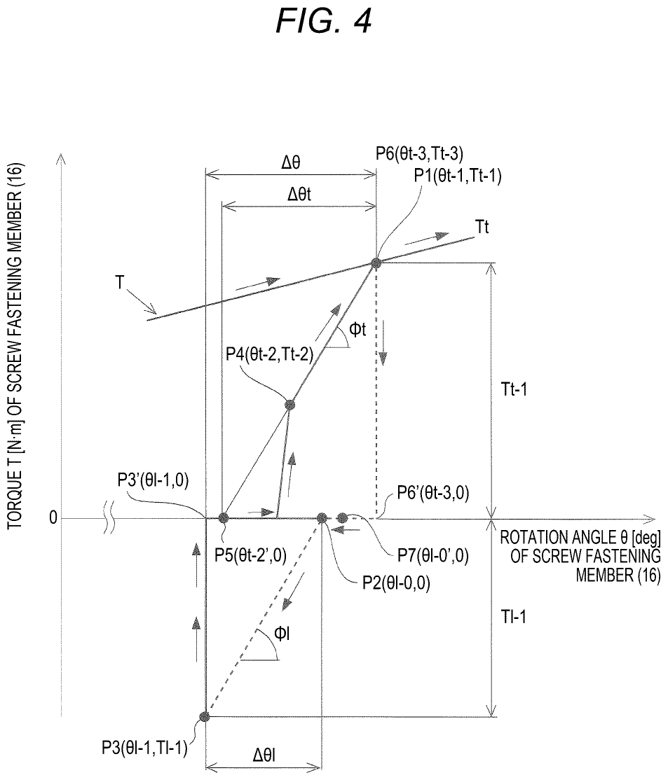

FIG. 1 is a schematic view illustrating a screw fastening body 11 that is screw-fastened using a screw fastening method for a fastening object member 10 according to the present embodiment. FIG. 2 is a flowchart illustrating the screw fastening method for the fastening object member 10 according to the present embodiment. FIG. 3 is a diagram illustrating the screw fastening method for the fastening object member 10 according to the present embodiment, and illustrates a relation between a torque T and a rotation angle θ of a screw fastening member 16. FIG. 4 is a diagram illustrating the screw fastening method for the fastening object member 10 according to the present embodiment, and illustrates a part of the diagram illustrated in FIG. 3 in an enlarged manner.

First, for example, in an automobile or the like, screw fastening using the screw fastening member 16 is used as a method of fixing a plurality of components as the fastening object member 10. The screw fastening is used not only in the field of automobiles but also in the fields of various mechanical structures such as aircrafts, railways, plants, and buildings. The mechanical structure includes a plurality of screw fastening bodies 11 to which the fastening object member 10 is screw-fastened as one of means for coupling the plurality of components to one another. By tightening the screw fastening bodies 11 with an accurate tightening axial force, strength or reliability required for the mechanical structure are implemented.

In the present embodiment, the screw fastening member 16 will be described using, for example, a bolt 12 having a male screw portion formed on a shaft portion 12A thereof, such as a through bolt, and a nut 13 having a female screw portion formed for screwing into the through bolt. However, the screw fastening member 16 is not limited to the bolt 12 and the nut 13, and for example, a pressing bolt or a stud bolt may be used as the bolt 12. In this case, instead of the nut 13, a female screw portion is formed on an inner surface of one of through holes 14A and 15A of the fastening object member 10, and the bolt 12 is tightened to one of the through holes 14A and 15A of the fastening object member 10.

As described above, in order to improve a strength or reliability of the mechanical structure, it is important not only to improve a strength of a material to be used as the fastening object member 10 but also to tighten the screw fastening body 11 in the mechanical structure with an accurate tightening axial force. The screw fastening body 11 is tightened with an accurate tightening axial force, so that not only the reliability of the screw fastening body 11 is ensured, but also a diameter of the bolt 12 can be reduced, or the number of bolts 12 used in the mechanical structure can be reduced. As a result, a weight of the screw fastening body 11 is reduced, so that a weight of the mechanical structure is also reduced, and a manufacturing cost of the mechanical structure is greatly reduced.

As illustrated in FIG. 1, the screw fastening body 11 includes the fastening object member 10, and a bolt 12 and a nut 13 that couple the fastening object member 10 by screw fastening. An example of the fastening object member 10 is steel materials 14 and 15, and the steel material 14 and 15 are formed with the through holes 14A and 15A along a central axis 17 indicated by a one-dot chain line, respectively.

For example, a through bolt is used as the bolt 12, and the male screw portion is formed on an outer peripheral surface of the shaft portion 12A of the bolt 12. The shaft portion 12A of the bolt 12 is inserted into the through holes 14A and 15A of the steel material 14 and 15 from a lower surface side of the fastening object member 10. A head portion 12B of the bolt 12 is in contact with a seating surface 15B of the steel material 15 and applies a tightening axial force F to the fastening object member 10.

A female screw portion is formed on an inner surface of the nut 13, and the nut 13 is screwed onto the male screw portion of the shaft portion 12A of the bolt 12 led out to an upper surface side of the fastening object member 10. When the nut 13 is tightened by a fastening tool such as a spanner, the nut 13 is in contact with the seating surface 14B of the steel material 14 and applies the tightening axial force F to the fastening object member 10.

As illustrated in FIG. 2, in the screw fastening method for the fastening object member 10 according to the present embodiment, it is possible to calculate a target tightening torque Tt-F corresponding to a predetermined target tightening axial force Ft with respect to a portion to be screw-fastened of a mechanical structure such as a vehicle, and screw-fasten the fastening object member 10 with the calculated target tightening torque Tt-F.

The screw fastening method for the fastening object member 10 mainly includes a process of temporarily tightening the fastening object member 10 by the screw fastening member 16 as step S10, a process of loosening the screw fastening member 16 and detecting a maximum value of a loosening torque as step S11, a process of re-tightening the screw fastening member 16 as step S12, a process of calculating the target tightening torque Tt-F as step S13, and a process of screw-fastening the fastening object member 10 with the target tightening torque Tt-F as step S14.

Although details will be described later with reference to FIGS. 3 and 4, and the like, in the screw fastening method for the fastening object member 10 according to the present embodiment, the screw fastening member 16 is loosened after the fastening object member 10 is temporarily tightened by the screw fastening member 16, and the screw fastening member 16 is shifted to a re-tightening operation immediately after a maximum value of a loosening torque Tl is detected in the loosening operation. A loosening direction torsion angle Δθl and a tightening direction torsion angle Δθt of the bolt are calculated using a loosening direction torque gradient Φl during the loosening operation and a tightening direction torque gradient Φt during the re-tightening operation.

That is, in the screw fastening method of the present embodiment, the target tightening torque Tt-F corresponding to the predetermined target tightening axial force Ft is calculated using the loosening direction torsion angle Δθl, the tightening direction torsion angle Δθt, a tightening torque Tt, and the like. The screw fastening method is less likely to be affected by a dynamic friction coefficient during the temporary tightening operation on the screw fastening member 16 and a static friction coefficient during the loosening operation on the screw fastening member 16, thereby reducing variation in error with respect to the predetermined target tightening axial force Ft.

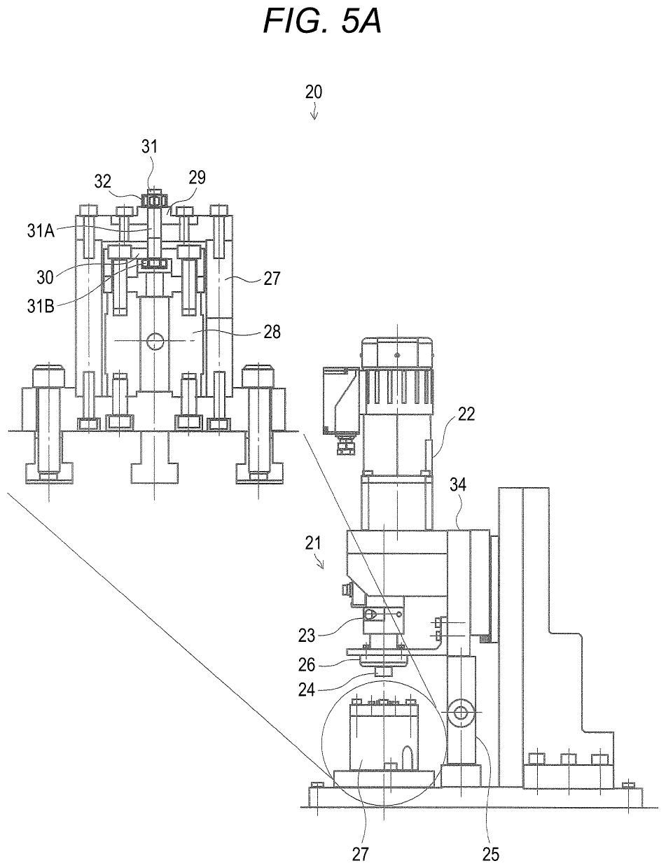

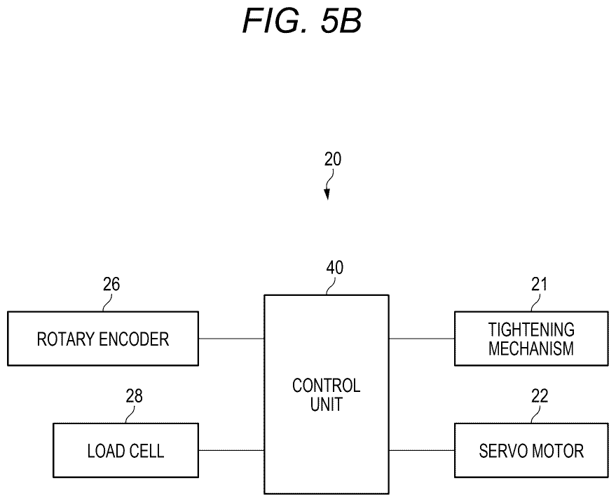

In the present embodiment, for convenience of description, the processes of the screw fastening method will be described separately as step S10 to step S14, and the present disclosure is not limited to this case. For example, the processes from step S10 to step S14 may be continuously performed in the screw fastening device 20 (see FIG. 5A) that implements the screw fastening method of the present embodiment.

In FIGS. 3 and 4, a vertical axis represents a torque T (N·m) applied to the screw fastening member 16, and a horizontal axis represents a rotation angle θ (deg) of the screw fastening member 16. The loosening operation on the screw fastening member 16 is an operation of causing the nut 13 to rotate in a direction opposite to a tightening direction. In the following description, FIG. 1 is referred to as appropriate.

In step S10, as illustrated in FIG. 1, the shaft portion 12A of the bolt 12 is inserted into the through holes 14A and 15A from the lower surface side of the fastening object member 10, and the nut 13 is screwed onto the male screw portion of the shaft portion 12A led out to the upper surface side of the fastening object member 10. Thereafter, the tightening torque Tt is applied to the nut 13 in the tightening direction via, for example, a wrench portion 24 (see FIG. 5A) which is a fastening tool. Then, the nut 13 rotates in the tightening direction via the wrench portion 24 until a first tightening torque Tt-1 set as a value of a temporary tightening torque is detected. An illustrated first inflection point P1 (θt-1, Tt-1) is a point set in advance for temporarily tightening the screw fastening member 16 up to a constant torque.

Here, in the screw fastening body 11, when the tightening axial force is F, the tightening torque is Tt, the loosening torque is Tl, an axial force torque is Tth, a screw portion friction torque due to contact surfaces between the male screw portion of the bolt 12 and the female screw portion of the nut 13 of the screw fastening member 16 is Ts, a seating surface friction torque between the nut 13 and the seating surface 14B of the steel material 14 of the fastening object member 10 is Tw, and an axial force torque of the bolt 12 is Tf, the following relational equation is established.

$$\begin{matrix}[ Equation 1 ] & \\ Tt = Ts + Tf + Tw & ( 1 )\end{matrix}$$

$$\begin{matrix}[ Equation 2 ] & \\ Tl = Ts - Tf + Tw & ( 2 )\end{matrix}$$

$$\begin{matrix}[ Equation 3 ] & \\ Tth = Ts + Tf & ( 3 )\end{matrix}$$

Further, when an effective diameter of the screw of the screw fastening body 11 is d2, a friction coefficient of a screw surface is μth, a flank angle in a mountain-perpendicular cross section is α′, a pitch of the screw is P, an equivalent torque diameter of the seating surface is Dw, and a friction coefficient of the seating surface is μw, the following relational equation is established.

$$\begin{matrix}[ Equation 4 ] & \\ Ts = ( d 2 / 2 ) ∼ µ th \cdot sec {α}^{′} \cdot F & ( 4 )\end{matrix}$$

$$\begin{matrix}[ Equation 5 ] & \\ Tf = ( P / 2 π ) \cdot F & ( 5 )\end{matrix}$$

$$\begin{matrix}[ Equation 6 ] & \\ Tw = ( Dw / 2 ) \cdot µ w \cdot F & ( 6 )\end{matrix}$$

In the present embodiment, the axial force torque Tf is derived in the process of the temporary tightening operation, the loosening operation, and the re-tightening operation on the screw fastening member 16, the tightening axial force Ft-1 at the time of temporary tightening is calculated according to Equation (5), and the target tightening torque Tt-F corresponding to the predetermined target tightening axial force Ft is calculated according to Equations (1) and (4) to (6).

In step S11, after the first tightening torque Tt-1 is detected, the loosening torque Tl is applied to the nut 13 via the wrench portion 24. As illustrated in FIGS. 3 and 4, there is a section in which the tightening torque Tt is 0 by a rotation angle of backlash between the nut 13 and the wrench portion 24, and then the loosening torque Tl increases in a negative direction. An illustrated second inflection point P2 (θl-0, 0) is a point detected after the backlash is eliminated. In addition, an illustrated third inflection point P3 (θl-1, Tl-1) is a point that is detected as the maximum value of the loosening torque Tl after the loosening operation.

At this time, the state of the shaft portion 12A of the bolt 12 is that after being twisted in the tightening direction by the tightening direction torsion angle Δθt, and is then twisted in the opposite loosening direction after the twist is once eliminated. That is, the shaft portion 12A of the bolt 12 is twisted in the loosening direction by the loosening direction torsion angle Δθl.

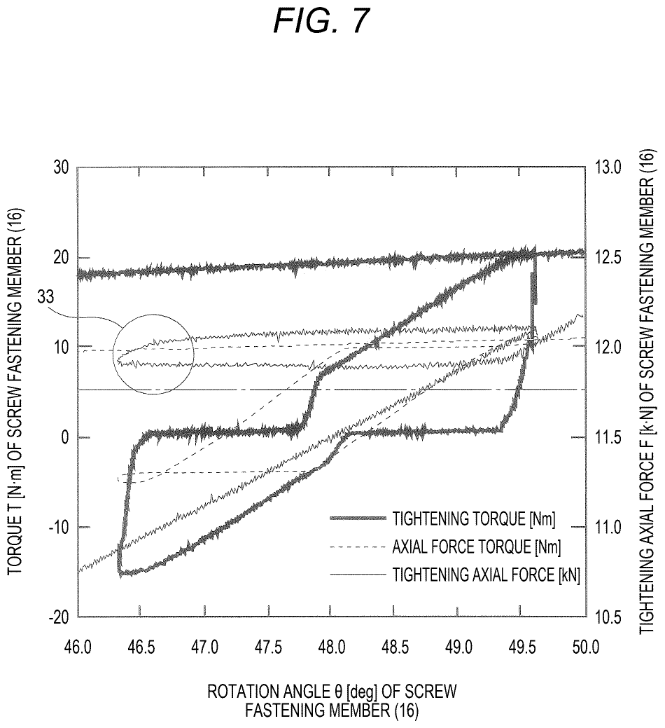

Thereafter, when the loosening operation is continued and exceeds a maximum value Tl-1 of the loosening torque Tl, screw surfaces of the bolt 12 and the nut 13 that mesh with each other start sliding in the loosening direction, and the tightening axial force F decreases. Therefore, in the present embodiment, after the shaft portion 12A of the bolt 12 is twisted in the loosening direction due to a screw portion friction at the contact surface of the screw fastening member 16, the re-tightening operation is performed again in the tightening direction before the nut 13 rotates in the loosening direction. As will be described later with reference to FIG. 7, in the screw fastening method of the present embodiment, the maximum value of the loosening torque Tl is detected, and thus the tightening axial force F slightly decreases, but this decrease in the tightening axial force F is a phenomenon that necessarily occurs, and it is possible to cope with the decrease in the tightening axial force F with calculation by incorporating a correction processing into an arithmetic equation in advance.

As a result, in the screw fastening method for the fastening object member 10 according to the present embodiment, the nut 13 does not substantially rotate, and thus the nut 13 is less likely to be affected by the static friction coefficient during the loosening operation on the screw fastening member 16. In the screw fastening method, the loosening direction torque gradient Φl is calculated in a state of being less likely to be affected by the static friction coefficient during the loosening operation, and the loosening direction torsion angle Δθl is calculated using the loosening direction torque gradient Φl. Then, the loosening direction torsion angle Δθl is also less likely to be affected by the static friction coefficient and is calculated with high accuracy. The loosening direction torsion angle Δθl may be directly detected based on a difference in rotation angle between the second inflection point P2 (θl-0, 0) and the third inflection point P3 (θl-1, Tl-1).

In step S12, the tightening torque Tt is applied to the nut 13 via the wrench portion 24 immediately after the maximum value TI-1 of the loosening torque Tl is detected. Then, by shifting to the re-tightening operation on the screw fastening member 16, as illustrated in FIGS. 3 and 4, there is the section in which the tightening torque Tt is 0 by the rotation angle of the backlash between the nut 13 and the wrench portion 24, and then the tightening torque Tt increases in a positive direction.

An illustrated fourth inflection point P4 (θt-2, Tt-2) is a point detected after the backlash is eliminated and exceeds the seating surface friction torque Tw. An illustrated fifth inflection point P5 (θt-2′, 0) is a point calculated by extrapolating the tightening direction torque gradient Φt at the time of re-tightening. An illustrated sixth inflection point P6 (θt-3, Tt-3) is a point detected when the nut 13 starts rotating again.

At this time, during the re-tightening operation, the tightening torque Tt rapidly increases by the seating surface friction torque Tw under the influence of a seating surface friction between the nut 13 and the seating surface 14B of the steel material 14 of the fastening object member 10. While the bolt 12 is twisted again in the tightening direction, the tightening torque Tt increases to a second tightening torque Tt-3. Theoretically, the second tightening torque Tt-3 coincides with the first tightening torque Tt-1. Step S12 is a stage before the nut 13 starts sliding in the tightening direction.

Here, the following relational equation is derived according to Equations (1) and (2).

$$\begin{matrix}[ Equation 7 ] & \\ Tf = ( \vert Tt \vert - \vert Tl \vert ) / 2 & ( 7 )\end{matrix}$$

In step S13, the target tightening torque Tt-F corresponding to the predetermined target tightening axial force Ft is calculated. As described above, the tightening torque Tt rapidly increases by the seating surface friction torque Tw, passes the inflection point P4 affected by the seating surface friction torque Tw, and then increases at the tightening torque gradient Φt. Therefore, in the screw fastening method of the present embodiment, in order to reduce the influence of the dynamic friction coefficient during the re-tightening operation, the tightening torque gradient Φt after passing the inflection point P4 is plotted linearly, and the inflection point P5, which is an intersection point with the tightening rotation angle θt on the horizontal axis, is calculated. The tightening direction torsion angle Δθt of the bolt 12 is defined as the following relational equation.

$$\begin{matrix}[ Equation 8 ] & \\ Δ θ t = θ t - 3 θ t - {2}^{′} & ( 8 )\end{matrix}$$

As described above, in the screw fastening method of the present embodiment, after the nut 13 rotates in the tightening direction up to the first tightening torque Tt-1, the loosening torque Tl is applied to the nut 13. Then, after the maximum value Tl-1 of the loosening torque Tl is detected, the tightening torque Tt is again applied to the nut 13 up to the second tightening torque Tt-3.

That is, in the present embodiment, the tightening direction torsion angle Δθt and the loosening direction torsion angle Δθl are calculated using a torsion phenomenon within an elastic range of the bolt 12, and the tightening direction torsion angle Δθt and the loosening direction torsion angle Δθl are used as parameters for calculating the target tightening torque Tt-F.

As illustrated in FIGS. 3 and 4, the loosening direction torsion angle Δθl of the bolt 12 is derived as the following relational equation.

$$\begin{matrix}[ Equation 9 ] & \\ Δ θ l = θ l - 0 - θ l - 1 & ( 9 )\end{matrix}$$

Here, as described above, the tightening torque gradient Φt of the bolt 12 theoretically coincides with the loosening direction torque gradient Φl of the bolt 12. However, for example, for some reason, the friction coefficient μth of the screw surface becomes smaller during the loosening operation than during a tightening operation, and the loosening direction torque gradient Φl may become smaller than the tightening torque gradient Φt.

Therefore, in the present embodiment, the loosening direction torque gradient Φl and the tightening torque gradient Φt are compared with each other, and when the loosening direction torque gradient Φl is different from the tightening torque gradient Φt by a threshold value of 5% or more, the loosening direction torque gradient Φl is replaced with the tightening torque gradient Φt to calculate an inflection point P7 (θl-0′, 0). Then, a value of the loosening direction torsion angle Δθl of the bolt 12 is corrected according to Equation (9).

As described above, using the fact that the loosening direction torque gradient Φl coincides with the tightening torque gradient Φt, the following relational equation is derived based on the following two similar triangles as illustrated in FIGS. 3 and 4. When a point obtained by perpendicularly dropping the inflection point P6 with respect to an axis of the rotation angle θ is defined as P6′ (θt-3, 0), and a point obtained by perpendicularly dropping the inflection point P3 (θl-1, Tl-1) with respect to the axis of the rotation angle θ is defined as P3′ (θl-1, 0), a triangle P6, P6′, P5 and a triangle P3, P3′, P2 have a similarity relation, and the following relational equation is derived.

$$\begin{matrix}[ Equation 10 ] & \\ Δ θ l : Δ θ t = Tl - 1 : Tt - 3 & ( 10 )\end{matrix}$$

The following relational equation is derived according to Equations (7) and (10).

$$\begin{matrix}[ Equation 11 ] & \\ Tf = Tt - 3 \cdot ( Δ θ t - Δ θ l ) / 2 \cdot Δ θ t & ( 11 )\end{matrix}$$

The tightening axial force Ft-1 at the time of temporary tightening is derived as the following relational equation according to Equation (5).

$$\begin{matrix}[ Equation 12 ] & \\ Ft - 1 = ( 2 π / P ) \cdot Tf & ( 12 )\end{matrix}$$

Finally, the target tightening torque Tt-F corresponding to the predetermined target tightening axial force Ft is calculated according to the following relational equation (13) using Equation (1).

$$\begin{matrix}[ Equation 13 ] & \\ Tt - F = Ts + Tf + Tw = ( Tt - 3 / Ft - 1 ) \cdot Ft & ( 13 )\end{matrix}$$

As described above, in the screw fastening method of the present embodiment, during the loosening operation on the screw fastening member 16, the tightening torque Tt is applied to cause the nut 13 to rotate in the tightening direction immediately after the maximum value Tl-1 of the loosening torque Tl is detected. Then, the tightening direction torsion angle Δθt and the loosening direction torsion angle Δθl are calculated using the torsion phenomenon within the elastic range of the bolt 12. As a result, the target tightening torque Tt-F corresponding to the predetermined target tightening axial force Ft can be calculated based on the torsion angles Δθt and Δθl of the bolt 12 in both the directions and the tightening torque Tt-3 at the time of re-tightening.

In other words, in the screw fastening method of the present embodiment, by deriving Equation (11) according to Equations (7) and (10), the tightening torque Tt or the loosening torque Tl, which are affected by the dynamic friction coefficient or the static friction coefficient, are replaced with the tightening direction torsion angle Δθt or the loosening direction torsion angle Δθl. As a result, the screw fastening method for the fastening object member 10 that is less likely to be affected by the dynamic friction coefficient during the temporary tightening operation on the screw fastening member 16 and the static friction coefficient during the loosening operation on the screw fastening member 16, and reduces the variation in error with respect to the predetermined target tightening axial force Ft is implemented.

Next, with reference to FIGS. 5 to 8, the screw fastening device 20 according to another embodiment of the present disclosure will be described in detail with reference to the drawings, and a verification experiment of the screw fastening method for the fastening object member 10 and a result thereof will be described.

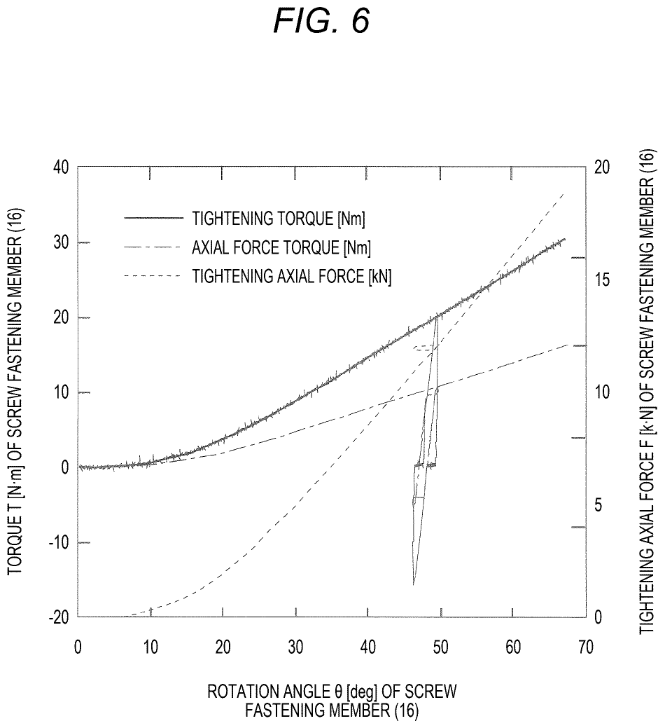

FIG. 5A is a schematic view illustrating the screw fastening device 20 that performs the screw fastening method for the fastening object member 10 according to the present embodiment. FIG. 5B is a block diagram illustrating the screw fastening device 20 according to the present embodiment. FIGS. 6 to 8 are diagrams each illustrating a result of a verification experiment of the screw fastening method for the fastening object member 10 according to the present embodiment. In the following description, a screw fastening method performed by the screw fastening device 20 refers to the screw fastening method for the fastening object member 10 described with reference to FIGS. 1 to 4, and the repeated description thereof will be omitted. In the description of the screw fastening device 20, the same components as those in the screw fastening method for the fastening object member 10 described with reference to FIGS. 1 to 4 are denoted by the same reference numerals, and the repeated description thereof will be omitted.

As illustrated in FIG. 5A, a tightening mechanism 21 includes the wrench portion 24 that fastens the nut 13 from a servo motor 22 located above the screw fastening device 20 via a torque converter 23. The tightening mechanism 21 is assembled to the screw fastening device 20 in a vertically movable state via a slide table 34. For example, the tightening mechanism 21 is moved up and down by a manual jack 25 installed below the slide table 34. The wrench portion 24 is fitted to the bolt 12 or the nut 13, and as described above, the screw fastening member 16 is temporarily tightened, loosened, or re-tightened.

The rotation angle θ of the wrench portion 24 can be directly measured by installing a cylindrical highly accurate rotary encoder 26 in the wrench portion 24. With this structure, the torque converter 23 or the servo motor 22 are less likely to be affected by a torsional elastic deformation, and the tightening rotation angle θ can be measured with high accuracy. During the loosening operation on the nut 13, the loosening torque Tl is less likely to be affected by the seating surface friction torque Tw, and the loosening direction torsion angle Δθl may be directly measured using the rotary encoder 26.

As illustrated in an upper left in FIG. 5A, in the screw fastening body 11, a cylindrical frame 27 is installed on a base of the screw fastening device 20, and a load cell 28 capable of simultaneously measuring a tensile force-compressive force and a torque is installed inside the cylindrical frame 27. The head portion 12B of the bolt 12 is fixed to an upper portion of the load cell 28 with width across faces and a bolt seating surface that are fixed to each other by a jig. The torque measurement mechanism of the present disclosure corresponds to the load cell 28 of the present embodiment.

As illustrated in FIG. 5, a disk including a seating surface portion 29 is installed on an upper portion of the cylindrical frame 27, and a test bolt 31 is fastened from above the disk with a test nut 32. With this structure, the tightening axial force F and the axial force torque Tth can be measured by separating a fixing portion 30 of the head portion 31B of the test bolt 31 from the seating surface portion 29.

As illustrated in FIG. 5B, the control unit 40 of the screw fastening device 20 includes a central processing unit (CPU), a read only memory (ROM), a random access memory (RAM), and the like. The control unit 40 is an electronic control unit (ECU) for controlling the operation and stop of the servo motor 22 or the tightening mechanism 21 according to an input signal from the load cell 28, the rotary encoder 26, or the like.

As described above with reference to FIGS. 1 to 4, the control unit 40 calculates the tightening torque gradient Φt, the loosening direction torque gradient Φl, the tightening direction torsion angle Δθt, the loosening direction torsion angle Δθl, and the like using measurement data from the load cell 28 or the rotary encoder 26. Then, the control unit 40 calculates the target tightening torque Tt-F, controls the tightening mechanism 21 or the like, and screw-fastens the fastening object member 10 with the target tightening torque Tt-F using the screw fastening member 16.

The screw fastening device 20 may include a movable arm (not illustrated) or an image recognition device (not illustrated), cause the screw fastening member 16 held by the tightening mechanism 21 to move to a fastening position of the fastening object member 10, and screw-fasten the fastening object member 10 using the screw fastening member 16 with the calculated target tightening torque Tt-F.

Next, a method of the verification experiment will be described. After the test bolt 31 and the test nut 32 as the screw fastening members 16 are cleaned using hexane, MoS2 grease is applied to a screw portion of the test bolt 31 and mated with the test nut 32, so that the MoS2 grease is spread thoroughly over screw surfaces of the test bolt 31 and the test nut 32. The MoS2 grease is also applied to a seating surface of the test nut 32 to maintain lubricity.

The test bolt 31 is a hexagonal bolt made of SCM435 having an M8 size and a strength classification of 10.9, and the shaft portion 31A has a length of 40 mm. On the other hand, the test nut 32 is made of S45C having a strength classification 8 and has a double-chamfering style. The test bolt 31 and the test nut 32 each have a surface on which a triiron tetraoxide film is coated.

In the verification experiment, in order to verify a torsional rigidity of the test bolt 31, three types of bolts are used: a test bolt 31X with an unprocessed shaft portion 31A having d=8 mm; a test bolt 31Y with a shaft portion 31A lathed to d=7.5 mm; and a test bolt 31Z with a shaft portion 31A lathed to d=7.0 mm. A hexagonal corner portion of a seating surface of the head portion 31B of the test bolt 31 may have a shape error such as a burr, and is machined at a right angle to the shaft portion 31A on a lathe before use.

As a condition of the verification experiment, first, the test nut 32 is temporarily tightened up to the first tightening torque Tt-1=20.5N·m which is the temporary tightening torque, and then the loosening torque Tl is applied to the test nut 32, and the maximum value Tl-1 of the loosening torque Tl is detected. Then, the tightening torque Tt is applied to the test nut 32 immediately after the detection of the maximum value is completed, the tightening is continued until the final target tightening axial force Ft=19 k·N, and then the tightening is completed.

In FIG. 6, a horizontal axis represents the rotation angle θ (deg) of the test nut 32 of the screw fastening member 16, a left vertical axis represents the torque T (N·m) of the screw fastening member 16, and a right vertical axis represents the tightening axial force F (k·N) of the screw fastening member 16. FIG. 6 illustrates a result of temporarily tightening the test bolt 31X up to the first tightening torque Tt-1=20.5 N·m, which is the temporary tightening torque, performing the loosening operation, detecting the maximum value Tl-1 of the loosening torque Tl, and then performing tightening until the final tightening axial force Ft=19 k·N. On the other hand, FIG. 7 illustrates a region at which the rotation angle θ is 46.0 degrees to 50.0 degrees in the result illustrated in FIG. 6 in an enlarged manner.

It was verified that the measurement results of FIGS. 6 and 7 are substantially the same as the theoretical behavior described with reference to FIGS. 3 and 4.

A region indicated by a circle 33 in FIG. 7 illustrates a behavior of the tightening axial force F in an operation region in which the tightening torque Tt is applied to the test nut 32 after the maximum value Tl-1 of the loosening torque Tl is detected. As described above, in the screw fastening method of the present embodiment, it is necessary to detect the maximum value Tl-1 of the loosening torque Tl during the loosening operation on the nut. Therefore, even if a reversing operation is performed so as to apply the tightening torque Tt to the test nut 32 immediately after the maximum value Tl-1 is detected, a slight decrease in the tightening axial force F occurs as illustrated in FIG. 7.

Therefore, in the screw fastening method for the fastening object member 10 according to the present embodiment, the slight decrease in the tightening axial force F is a behavior that necessarily occurs, and can be theoretically corrected in advance. Then, by incorporating a correction processing into an arithmetic equation and correcting the slight decrease in the axial force, the screw fastening method for the fastening object member 10 in which the variation in the error with respect to the predetermined target tightening axial force Ft is reduced is implemented.

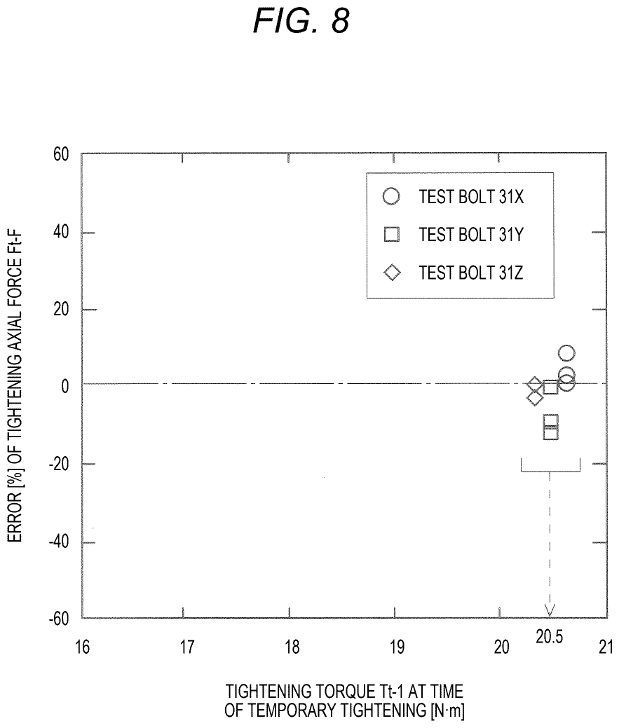

Next, FIG. 8 illustrates measurement results obtained by using the three types of test bolt 31X, test bolt 31Y, and test bolt 31Z described above under conditions of the first tightening torque Tt-1=20.5 N·m, which is a temporary tightening torque, and the final tightening axial force Ft=15 k·N. In FIG. 8, a horizontal axis represents the first tightening torque Tt-1 (N·m), which is the temporary tightening torque, and a vertical axis represents an error (%) of the tightening axial force Ft with respect to the final tightening axial force Ft=15 k·N. ○ indicates a result of the test bolt 31X, □ indicates a result of the test bolt 31Y, and ⋄ indicates a result of the test bolt 31Z.

As illustrated in FIG. 8, the three verification experiments were performed on the test bolt 31X, the test bolt 31Y, and the test bolt 31Z under the same conditions, and it was verified that the error of the tightening axial force Ft is within about 10% regardless of a size of a diameter of the shaft portion 31A of the test bolt 31.

In the screw fastening method for the fastening object member according to the embodiment of the present disclosure, the temporary tightening operation, the loosening operation, and the re-tightening operation are performed on the screw fastening member, and the target tightening torque corresponding to the predetermined target tightening axial force is calculated using the loosening direction torsion angle of the bolt and the tightening direction torsion angle of the bolt of the screw fastening member during the above operations. After the re-tightening operation, the fastening object member is screw-fastened with the calculated target tightening torque. According to the screw fastening method, the screw fastening method for the fastening object member that is less likely to be affected by the dynamic friction coefficient during the tightening operation on the screw fastening member and the static friction coefficient during the loosening operation on the screw fastening member, and reduces the variation in the error with respect to the predetermined target tightening axial force is implemented.

By implementing the screw fastening method, the screw fastening device according to the embodiment of the present disclosure is less likely to be affected by the dynamic friction coefficient during the tightening operation on the screw fastening member and the static friction coefficient during the loosening operation on the screw fastening member. In the screw fastening device, the screw fastening of the fastening object member in which the variation in the error with respect to the predetermined target tightening axial force is reduced is implemented.

In the screw fastening method for the fastening object member 10 according to the present embodiment, the case in which the target tightening torque Tt-F corresponding to the predetermined target tightening axial force Ft is calculated, and the fastening object member 10 is screw-fastened with the calculated target tightening torque Tt-F has been described, and the present disclosure is not limited to this case. For example, at a design stage of the screw fastening body 11, the target tightening torque Tt-F may be calculated using the screw fastening method for the fastening object member 10 according to the present embodiment, and the plurality of target screw fastening bodies 11 to be the target may be screw-fastened based on the calculation result in a manufacturing site. In addition, various modifications can be made without departing from the gist of the present disclosure.

What is claimed is:

1. A screw fastening method for a fastening object member that uses a screw fastening member to couple the fastening object member by screw tightening with a target tightening torque corresponding to a predetermined target tightening axial force, the screw fastening method comprising:
tightening the screw fastening member in a tightening direction up to a first tightening torque;
loosening the screw fastening member in a loosening direction opposite to the tightening direction and detecting a maximum value of a loosening torque;
re-tightening the screw fastening member in the tightening direction up to a second tightening torque after the maximum value of the loosening torque is detected; and
calculating the target tightening torque and tightening the screw fastening member up to the target tightening torque, wherein
the target tightening torque is calculated using a loosening direction torsion angle of a bolt of the screw fastening member when the screw fastening member is loosened and a tightening direction torsion angle of the bolt when the screw fastening member is re-tightened.

2. The screw fastening method for the fastening object member according to claim 1, wherein
the loosening direction torsion angle is calculated by directly measuring the bolt of the screw fastening member, and
the tightening direction torsion angle is calculated using a tightening torque gradient when the screw fastening member is re-tightened.

3. The screw fastening method for the fastening object member according to claim 1, wherein
the loosening direction torsion angle is calculated using a loosening torque gradient when the screw fastening member is loosened, and the tightening direction torsion angle is calculated using a tightening torque gradient when the screw fastening member is re-tightened.

4. The screw fastening method for the fastening object member according to claim 2, wherein
the tightening torque gradient is a torque gradient after passing an inflection point after an increase caused by a seating surface torque between the screw fastening member and a seating surface of the fastening object member.

5. The screw fastening method for the fastening object member according to claim 3, wherein
the tightening torque gradient is a torque gradient after passing an inflection point after an increase caused by a seating surface torque between the screw fastening member and a seating surface of the fastening object member.

6. The screw fastening method for the fastening object member according to claim 4, wherein
the tightening direction torsion angle is calculated by linearly extrapolating the tightening torque gradient from the inflection point and using an intersection point with an axis of a tightening rotation angle of the screw fastening member.

7. The screw fastening method for the fastening object member according to claim 5, wherein
the tightening direction torsion angle is calculated by linearly extrapolating the tightening torque gradient from the inflection point and using an intersection point with an axis of a tightening rotation angle of the screw fastening member.

8. The screw fastening method for the fastening object member according to claim 6, wherein
the loosening direction torsion angle is a torsion angle of the bolt after backlash between the screw fastening member and a fastening tool for operating the screw fastening member.

9. The screw fastening method for the fastening object member according to claim 7, wherein
the loosening direction torsion angle is a torsion angle of the bolt after backlash between the screw fastening member and a fastening tool for operating the screw fastening member.

10. The screw fastening method for the fastening object member according to claim 3, wherein
when the tightening torque gradient becomes larger than the loosening torque gradient by more than a threshold value, the loosening direction torsion angle is calculated after the loosening torque gradient is replaced with the tightening torque gradient.

11. The screw fastening method for the fastening object member according to claim 4, wherein
when the tightening torque gradient becomes larger than the loosening torque gradient by more than a threshold value, the loosening direction torsion angle is calculated after the loosening torque gradient is replaced with the tightening torque gradient.

12. The screw fastening method for the fastening object member according to claim 5, wherein
when the tightening torque gradient becomes larger than the loosening torque gradient by more than a threshold value, the loosening direction torsion angle is calculated after the loosening torque gradient is replaced with the tightening torque gradient.

13. A screw fastening device configured to use a screw fastening member to couple a fastening object member by screw tightening with a target tightening torque corresponding to a predetermined target tightening axial force, the screw fastening device comprising:
a tightening mechanism configured to tighten or loosen the screw fastening member disposed on the fastening object member;
a torque measurement mechanism configured to measure a torque when the screw fastening member is tightened or loosened by the tightening mechanism; and
a control unit, wherein
the control unit is configured to
perform a temporary tightening operation of tightening the screw fastening member in a tightening direction up to a first tightening torque using the tightening mechanism, and then perform a loosening operation of loosening the screw fastening member in a loosening direction opposite to the tightening direction,
detect a maximum value of a loosening torque during the loosening operation using the torque measurement mechanism, and then perform a re-tightening operation of tightening the screw fastening member in the tightening direction up to a second tightening torque using the tightening mechanism, and
calculate the target tightening torque using a loosening direction torsion angle of a bolt of the screw fastening member during the loosening operation and a tightening direction torsion angle of the bolt during the re-tightening operation.

14. The screw fastening device according to claim 13, wherein
the tightening mechanism comprises a rotary encoder disposed in a wrench portion of the screw fastening member that is fitted to the bolt or a nut, and
the control unit is configured to measure the loosening direction torsion angle using the rotary encoder.

15. The screw fastening device according to claim 14, wherein
the control unit is configured to calculate the tightening direction torsion angle using a tightening torque gradient during the re-tightening operation.

16. A screw fastening device comprising:
a screw fastening member configured to couple a fastening object member by screw tightening with a target tightening torque corresponding to a predetermined target tightening axial force;
a tightening mechanism configured to tighten or loosen the screw fastening member disposed on the fastening object member;
a torque measurement mechanism configured to measure a torque when the screw fastening member is tightened or loosened by the tightening mechanism; and
a processor configured to execute a program stored in a memory, wherein
the processor configured is configured to, when the program is executed by the processor, cause the screw fastening device to execute:
tightening the screw fastening member in a tightening direction up to a first tightening torque using the tightening mechanism, and then loosening the screw fastening member in a loosening direction opposite to the tightening direction,
detecting a maximum value of a loosening torque during loosening the screw fastening member using the torque measurement mechanism, and then re-tightening the screw fastening member in the tightening direction up to a second tightening torque using the tightening mechanism, and
calculating the target tightening torque using a loosening direction torsion angle of a bolt of the screw fastening member during loosening the screw fastening member and a tightening direction torsion angle of the bolt during re-tightening the screw fastening member.
